(19) United States
(12) Patent Application Publication
(10) Pub. No.: US 2007/0193797 A1
(43) Pub. Date: Aug. 23, 2007

(54) Pressure booster system

(76) Inventors: Dmitry A. Shamis, Commerce Township, MI (US); William Eybergen, Windsor (CA)

Correspondence Address: DYKEMA GOSSETT PLLC, 39577 WOODWARD AVENUE, SUITE 300, BLOOMFIELD HILLS, MI, 48304-5086, US

(21) Appl. No.: 11/359,919

(22) Filed: Feb. 22, 2006

(51) Int. Cl. B60K 25/10

(52) U.S. Cl. 180/165

(57) ABSTRACT

A pressure booster system including a pressure booster; an engine in fluid communication with the pressure booster; and a compressed fluid storage tank in fluid communication with the pressure booster. The engine provides fluid to the pressure booster and the fluid can be used to compress fluid supplied to the storage tank. A pressure booster system for use with an engine and a method for charging compressed fluid in a storage tank of a system are also disclosed.

### FIELD OF THE DISCLOSURE

The present disclosure relates generally to pressure booster systems and to a pressure booster for a compressed fluid storage tank of an air hybrid system.

### BACKGROUND

Conventional air hybrid systems typically include an engine in fluid communication with a compressed air storage tank. For example, with reference to FIGS. 3A and 3B, a conventional air hybrid system 200 is generally depicted. As shown, valves 206a, 206b may be located at or about an inlet 208 and an outlet 210 of the tank 204. Further, the engine 202, which may operate as an internal combustion (IC) engine for a motor vehicle, may be an air compressor that that charges/compresses air in the tank 204. As shown in FIG. 3B, once the air in the tank 204 is charged, the compressed air may be utilized for operating a system of a motor vehicle.

Although adequate for most applications, the compression of the air in the storage tank 204 is limited by the characteristics of the engine 202. Thus, the power provided to a system is limited by the pressure of the compressed air in the tank 204. However, for some applications it may be desirable to provide an improved air hybrid system that increases pressure of compressed air.

### SUMMARY

A pressure booster system including a pressure booster; an engine in fluid communication with the pressure booster; and a compressed fluid storage tank in fluid communication with the pressure booster. The engine provides fluid to the pressure booster and the fluid can be used to compress fluid supplied to the storage tank. A pressure booster system for use with an engine and a method for charging compressed fluid in a storage tank of a system are also disclosed.

### BRIEF DESCRIPTION OF THE DRAWINGS

Embodiments of the disclosure will now be described, by way of example, with reference to the accompanying exemplary drawings, wherein:

FIGS. 1A and 1B are diagrams of an air hybrid system including a pressure booster according to an embodiment;

FIGS. 2A and 2B are diagrams of an air hybrid system including a pressure booster according to another embodiment of the present invention; and

FIGS. 3A and 3B are diagram views of a convention air hybrid system.

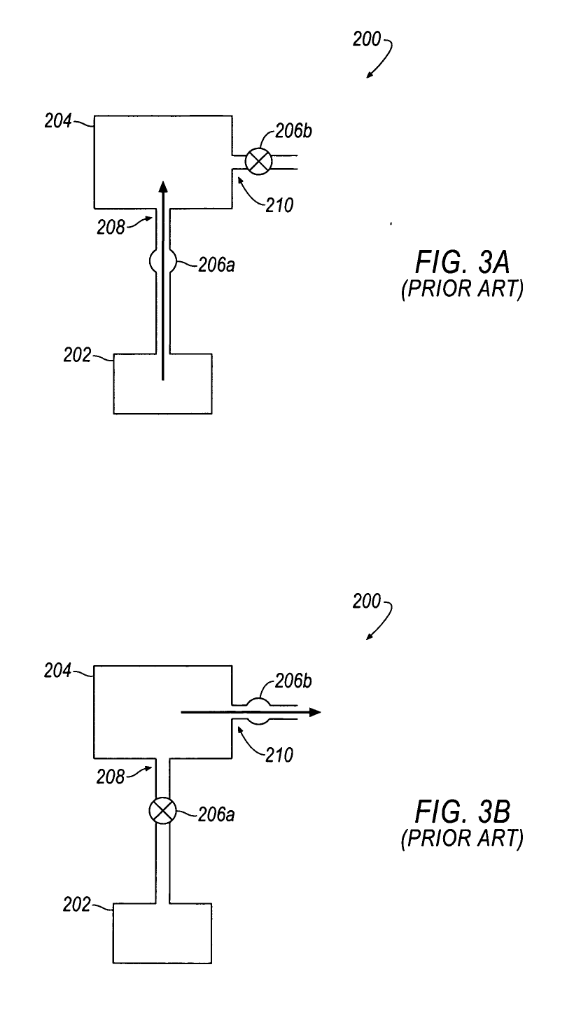

### DETAILED DESCRIPTION

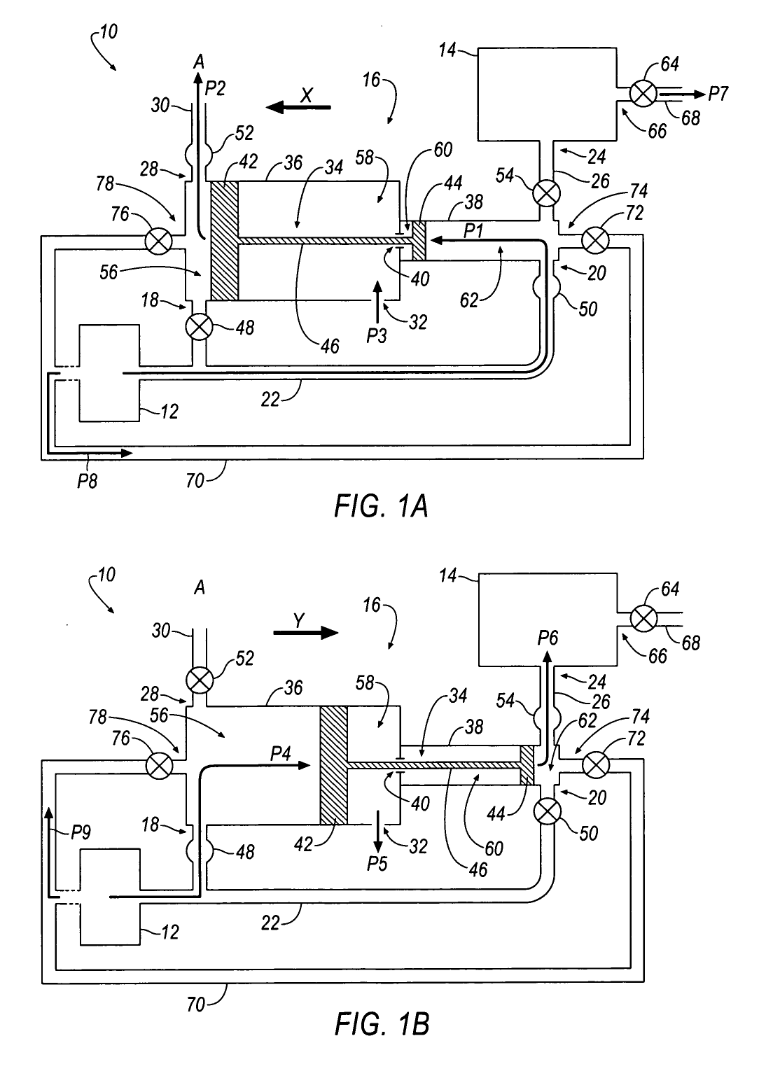

An air hybrid system, according to an embodiment, is generally depicted 10 in FIGS. 1A and 1B. The air hybrid system 10 generally includes an engine 12, a compressed fluid storage tank 14 and a pressure booster 16. It will be appreciated that the storage tank 14 and pressure booster 16 may contain and operate, respectively, with any compressible fluid, i.e., “fluid,” including, but not limited to, air, gas, or the like. As illustrated, the engine 12 is in fluid communication with the pressure booster 16 at first and second pressure booster inlets 18, 20 by way of a passage 22. The pressure booster 16 is also in fluid communication with the storage tank 14 at a storage tank inlet 24 by way of a passage 26. Additionally, the pressure booster 16 is in fluid communication with atmosphere or another external environment, depicted A, by way of an outlet 28 including a passage 30. The pressure booster 16 is also in fluid communication with atmosphere A by way of an opening 32 formed in a wall of the pressure booster 16.

The engine 12, which may also operate as an internal combustion (IC) engine for a motor vehicle, may function as an air compressor that provides a means to operate the pressure booster 16 for charging/compressing a fluid, such as air, in the tank 14. In an embodiment, the pressure booster 16 may include a reciprocating member 34 (e.g., a piston) disposed in a body having a first chamber 36 that is in fluid communication a second chamber 38 by way of an opening 40. Reciprocating member 34 may, for example, include a first end 42 that is connected to a second end 44 by way of a connector or connecting body 46, such as a stem, that may extend through opening 40. In the illustrated embodiment, the first end 42 is disposed in the first chamber 36 and the second end 44 is disposed in the second chamber 38.

The reciprocation of member 34 in the direction of arrow X (see, e.g., FIG. 1A) and the direction of arrow Y (see, e.g., FIG. 1B) may be determined or controlled by the opening and closing valves 48 and 54. Valves 48 and 50 associated with (and if desired, in proximity with) first and second pressure booster inlets 18, 20, respectively, may be in fluid communication with the engine 12, for example, by way of a passage, such as passage 22.

For example, the opening of the valve 48 (and the closing of valve 50) can initiate a down-stroke of member 34, and the opening of the valve 50 (and the closing of valve 48) can initiate an upstroke of member 34. A valve 52 associated with a first outlet 28 of the pressure booster 16 to exhaust gas/air from first chamber 36 (e.g., to atmosphere A) during an upstroke of the member 34 (i.e., a movement in the direction of arrow X). Valve 54 associated with passage 26 may, if desired be located in proximity to storage tank inlet 24, and may serve to evacuate gas/air from a second chamber 38 for charging/compressing the air in the tank 14. For example, without limitation, valves 48, 52, 64 may be electronically controlled, such as by an intelligent system, and valves 50 and 54 may comprise one-way valves, such as Reed valves. Although valves some of the aforementioned valves are discussed as potentially being electronically controlled and other valves are discussed as potentially being one-way valves, it will be understood by those of skill in the art that the aforementioned valves are not limited by such disclosure and they may instead comprise various other types of valves and/or combinations of valves.

In describing the operation of the pressure booster 16, the first chamber 36 can include a first variable area 56 and second variable area 58, which may comprise the areas (and associated volumes) formed within chamber 36 on opposite sides of first end 42. As illustrated, the reciprocating movement of the first end 42 of the member 34 within the first chamber 36 generally defines or controls the amount of area (and associated volume) associated with each of the first and second variable areas 56,58. The second chamber 38 may also include a first variable area 60 and second variable area 62, which may comprise the areas (and associated volumes) formed within chamber 38 on opposite sides of second end 44. As illustrated, the reciprocating movement of the second end 44 of the member 34 within the second chamber 38 generally defines or controls the amount of area (and associated volume) associated with each of the first and second variable areas 60,62.

During an upstroke of member 34, for example as generally shown in the embodiment illustrated in FIG. 1A, valves 48 and 54 are in a closed state and valves 50 and 52 are in an open state such that a pressurization of the second variable area 62 in the second chamber 38 occurs with air from the engine 12 flowing thereto in the direction of arrow P1 to cause member 34 to generally move in the direction depicted by arrow X. To evacuate air from the first variable area 56 in the first chamber 36 during an upstroke of member 34, air is allowed to be dispelled from the first variable area 56 in the first chamber 36 to atmosphere A from outlet 28 in the direction of arrow P2 through the valve 52. Additionally, air is drawn from atmosphere A into the second variable area 58 in the first chamber 36 through one or more openings (such as opening 32), such a flow generally depicted by arrow P3.

During a down-stroke of member 34, for example as generally shown in the embodiment illustrated in FIG. 1B, valves 48 and 54 are in an open state and the valves 50 and 52 are in a closed state such that a pressurization of the first variable area 56 in the first chamber 36 occurs with air from the engine 12 flowing thereto in the direction of arrow P4 to cause member 34 to generally move in the direction depicted by arrow Y, which is generally opposite the direction depicted by arrow X. To evacuate air from the second variable area 58 in the first chamber 36 during the down-stroke of member 34, air may be permitted to be evacuate or be dispelled from the second variable area 58 in the first chamber 36 to atmosphere A from the second outlet 32 in the direction generally depicted by arrow P5. The pressure of the air from the engine 12 along paths P1, P4 (i.e., for causing the upstroke and down-stroke of member 34) may be, for example, approximately 20-bar.

During a down-stroke of member 34 (generally in the direction depicted by arrow Y), air in the second variable area 62 of the second chamber 38 is evacuated generally in the direction depicted by arrow P6 to charge/compress the air in the tank 14. If desired, the area (or volume) of the second chamber 38 can be minimized (relative to the area in the first chamber 36) to increase the resulting pressure of the air in the tank 14. As is known to one skilled in the art, pressure is force per unit area acting on a surface in a direction perpendicular to that surface and is mathematically represented by the equation P=F/A, where P is pressure, F is force, and A is area. As a result, the smaller the area of the second chamber 38, the greater the air (or other fluid) may be pressurized (i.e. charged) in the tank 14. Although the area of the second chamber 38 may vary from application to application, it will be appreciated that the air provided by the engine 12 may be amplified by the pressure booster 16 to any desirable level, such as, for example approximately ten times the pressure provided by the engine air (e.g., 20-bar times 10=200-bar).

Upon completion of the down-stroke of member 34 in the direction depicted by arrow Y, the valve 54 is closed, thereby retaining the relatively high air pressure in the tank 14 in view of the pressure provided by the engine 16 as amplified by the pressure booster 16. When a system, such as, for example, a motor vehicle acceleration or launch-assist propulsion system is operated, a valve 64 associated with passage 68 and, if desired, proximate a tank outlet 66 may be opened so that the charged/compressed air in the tank 14 is provided to the system through passage 68 in the direction generally depicted by arrow P7 (see, e.g., FIG. 1A). In an alternative embodiment, if the pressure of air in the tank 14 is lower than the pressure of the air provided by the engine 12, the pressure booster 16 may initially be bypassed to bring the tank 14 up to a minimum “engine out” pressure level by keeping valve 48 closed and valves 50, 54 open so that combustible air may flow directly from the engine 12 to the tank 14.

According to an embodiment of the invention, exhaust gas from the engine 12 may flow from a passage 70 to the pressure booster 16. The exhaust gas pressure may arise, for example, from engine braking, deceleration, or a turbocharger. As similarly described above, exhaust gas may flow in the passage 70 in the direction depicted by arrow P8 for operating the upstroke of member 34 when the valve 72 is opened so that the exhaust gas may flow through a third pressure booster inlet 74. To operate the down-stroke of member 34, exhaust gas may flow in the passage 70 in the direction generally depicted by arrow P9 when the valve 76 is opened so that the exhaust may flow through a fourth pressure booster inlet 78. If desired, combustible air from the engine and exhaust air from the engine may be simultaneously used to operate the upstroke and down-stroke of the pressure booster 16. Although two passages 22, 70 and four pressure booster inlets 18, 20, 74, 78 are shown, it will be appreciated that the air hybrid system 10 comprise additional configurations and may, for example and without limitation, be reduced to one passage and two inlets for the utilization of combustible and exhaust air.

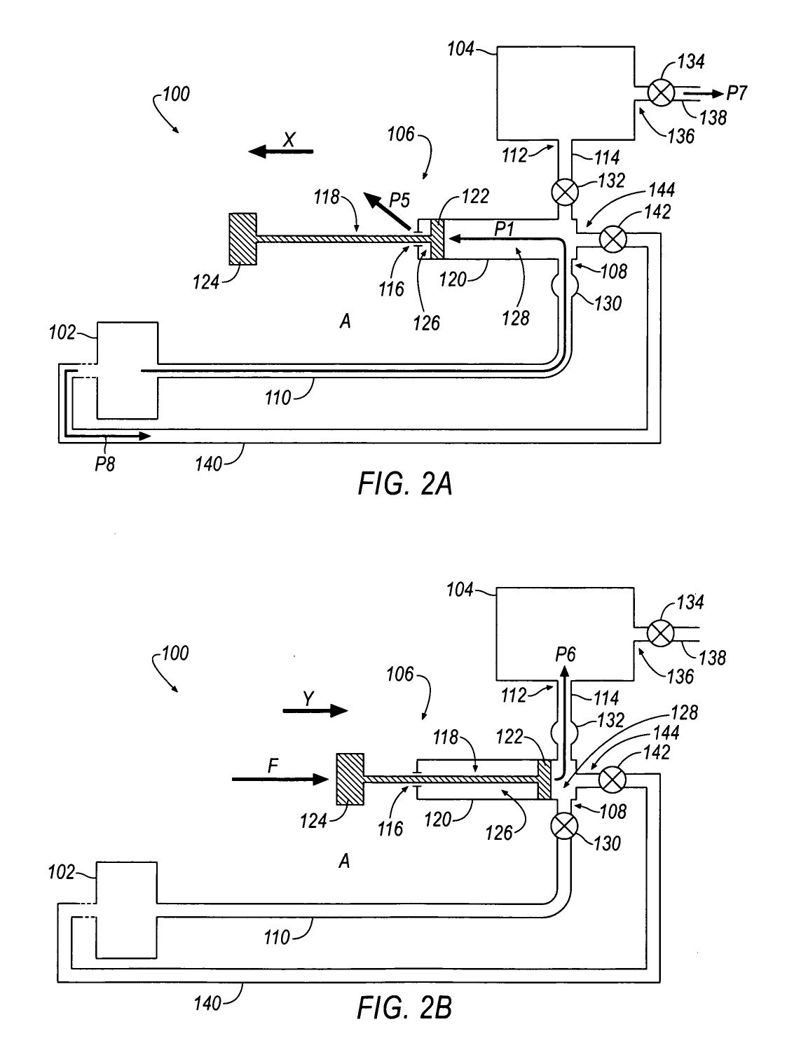

Referring to FIGS. 2A and 2B, an air hybrid system according to another embodiment is generally depicted as 100. The illustrated air hybrid system 100 generally includes an engine 102, a compressed fluid storage tank 104 and a pressure booster 106. In an embodiment, the engine 102 is in fluid communication with the pressure booster 106 by way of a pressure booster inlet 108 through a passage 110. The pressure booster 106 is also in fluid communication with the storage tank 104 at a storage tank inlet 112 by way of a passage 114. Additionally, the pressure booster 106 is in fluid communication with atmosphere A by way of an opening 116 formed in the pressure booster 106.

The engine 102, which may also operate as an internal combustion (IC) engine for a motor vehicle, may function as an air compressor that provides a means to operate the upstroke of the pressure booster 106 as a first step in the process of charging/compressing a fluid (e.g., air) in the tank 104. The pressure booster 106 may include a positive displacement pump 118 disposed in a fluid chamber body 120. As illustrated, the positive displacement pump 118 may include a first end 122 and a second end 124. In describing the operation of the pressure booster 106, the air chamber body 120 may include a first variable area (or volume) 126 and second variable area (or volume) 128. As illustrated, the reciprocating movement of the first end 122 of the positive displacement pump 118 within the air chamber body 120 generally defines the associated area (or volume) for the first and second variable areas 126,128.

Referring to FIG. 2A, during an upstroke of positive displacement pump 118, a valve 130 used in connection with and, if desired, in proximity to pressure booster inlet 108, may be in an open state, while a valve 132 associated with passage 114 and, if desired, proximate storage tank inlet 112, may be in a closed state such that a pressurization second variable area 128 in the air chamber body 120 can occur. With such a pressurization, air pressure from the engine 102 flowing in the direction generally depicted by arrow P1 can cause the positive displacement pump 118 to move in the direction generally depicted by arrow X. To evacuate gas/air from the first variable area 126 during the upstroke of the positive displacement pump 118, gas/air is permitted to evacuate or be dispelled from the first variable area 126 to atmosphere (or another external environment) A from outlet 116 in the direction generally depicted by arrow P5.

Referring to FIG. 2B, a down-stroke of the positive displacement pump 118 can occur by way of a force F applied to the second end 124 of the positive displacement pump 118 in the direction generally depicted by arrow Y, which is generally opposite the direction depicted by arrow X. The force F may arise from a source, such as, for example, a crankshaft, a motor, a screw-compressor, an electrical/mechanical system, or the like. Once the force F is applied, valve 130 is in a closed state and the valve 132 is in an open state to charge/compress air in the tank 104 with air being pumped from the second variable area 128 in the direction generally depicted by arrow P6. Upon completion of the down-stroke of the positive displacement pump 118 in the direction generally depicted by arrow Y, the valve 132 is closed, thereby retaining a relatively high air pressure in the tank 104. When a system, such as, for example, a motor vehicle acceleration or launch-assist propulsion system, is operated, a valve 134 proximate a tank outlet 136 may be opened such that the charged/compressed air in the tank 104 may be provided to such a system through a passage 138 in the direction generally depicted by arrow P7 (see, e.g., FIG. 2A). According to an embodiment, valves 130, 132 may be one-way valves, such as, for example, Reed valves, and the valve 134 may be electronically controlled by a control system. Although the valves 130, 132 may be one-way valves and valve 134 may be electronically controlled, the valves 130-134 may be controlled in any desirable fashion. Although, as previously noted, the invention is not limited to the valves disclosed and described.

As similarly described above, the pressure of the air from the engine 102 according to the path P1 for causing the upstroke pump 118 may be, for example, approximately 20-bar. Although the area of the air chamber body 120 may vary from application to application, it will be appreciated that the air provided by the engine 102 may be amplified by the pressure booster 106 to any desirable level, such as, for example approximately ten times the pressure provided by the engine air (e.g., 20-bar times 10=200-bar).

According to an embodiment of the invention, exhaust gas from the engine 102 may flow from a passage 140 to the pressure booster 106. The exhaust gas pressure may arise from engine braking, deceleration, or a turbocharger. As similarly described above, exhaust gas may flow in the passage 140 in the direction generally depicted by arrow P8 for operating the upstroke of the pump 118 when a valve 142 is opened so that the exhaust gas may flow through a second pressure booster inlet 142. If desired, combustible air from the engine 102 and exhaust air from the engine 102 may be simultaneously used to operate the upstroke and down-stroke of the pressure booster 16. Although two passages 110, 140 and two pressure booster inlets 108, 144 are shown, it will be appreciated that an air hybrid system 100 according to the present invention may take on a variety of additional forms and may, by way of example and without limitation, be reduced to one passage and one inlet for the utilization of combustible and exhaust air.

The present invention has been particularly shown and described with reference to the foregoing embodiments, which are merely illustrative of the best mode or modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A pressure booster system, comprising:
a pressure booster;
an engine in fluid communication with the pressure booster; and
a compressed fluid storage tank in fluid communication with the pressure booster,
wherein the engine provides fluid to the pressure booster and the fluid can be used to compress fluid supplied to the storage tank.

2. The system according to claim 1, wherein the pressure booster includes a body and a reciprocating member disposed in the body.

3. The system according to claim 2, wherein the reciprocating member includes a piston.

4. The system according to claim 2, wherein the body includes a first chamber, a second chamber, and an opening between the first chamber and the second chamber.

5. The system according to claim 4, wherein the reciprocating member includes a first end at least partially disposed in the first chamber, a second end at least partially disposed in the second chamber, and a connector connecting the first end to the second end.

6. The system according to claim 5, wherein the connector connecting the first end to the second end extends through the opening between the first chamber and the second chamber.

7. The system according to claim 5, wherein the first chamber includes a first variable area and second variable area; the second chamber includes a first variable area and a second variable area; and wherein the volumes associated with the first and second variable areas of both the first chamber and the second chamber change in response to the reciprocating movement of the reciprocating member.

8. The system according to claim 2, wherein the system includes a plurality of valves and the reciprocating movement of the reciprocating member is controlled or directed by the opening and/or closing of one or more valves.

9. The system according to claim 8, wherein the plurality of valves includes a first valve located along a fluid passage between the engine and a first pressure booster inlet, and a second valve located along a fluid passage between the engine and a second pressure booster inlet.

10. The system according to claim 9, wherein the first pressure booster inlet is in communication with a first chamber of the power booster, and the second pressure booster inlet is in communication with a second chamber of the power booster.

11. The system according to claim 9, wherein the plurality of valves further includes a third valve for exhausting fluid from the first chamber to an atmosphere or an external environment; and a fourth valve located along a passage between the second chamber and the storage tank for supplying or charging the storage tank with compressed fluid.

12. The system according to claim 11, wherein during a down-stroke of the reciprocating member, the first and fourth valves are open, the second and third valves are closed, fluid is directed from the engine to the first chamber, and compressed fluid is supplied to the storage tank.

13. The system according to claim 11, wherein during an up-stroke of the reciprocating member, the first and fourth valves are closed, the second and third valves are open, and fluid is directed from the engine to the second chamber.

14. The system according to claim 1, wherein the pressure booster includes a positive displacement pump disposed in a fluid chamber body.

15. The system according to claim 14, wherein the fluid chamber body includes a first variable area defining a first variable volume, and a second variable area defining a second variable volume; and further wherein the reciprocating movement of a first end of the positive displacement pump disposed within the fluid chamber body alters the volumes associated with the first variable volume and the second variable volume.

16. The system according to claim 15, wherein an movement of the positive displacement pump is controlled or directed by opening or closing a first valve located along a passage between the engine and the fluid chamber body, and the opening or closing of a second valve located along a passage between the fluid chamber body and the storage tank.

17. The system according to claim 16, wherein when the first valve is in an open state and the second valve is in a closed state, the engine directs fluid to the fluid chamber of the body to at least in part cause an upstroke movement of the positive displacement pump.

18. The system according to claim 16, wherein when the first valve is in a closed state, the second valve is in an open state, and a force is applied to the positive displacement pump to compress the fluid within the fluid chamber body, compressed fluid is directed to the storage tank.

19. The system according to claim 1, wherein the pressure booster is in fluid communication with atmosphere or an external environment by way of an opening formed in the pressure booster.

20. The system according to claim 2, wherein the system includes at least one exhaust passage from the engine to the pressure booster and a valve located along the at least one exhaust passage.

21. The system according to claim 20, wherein exhaust from the engine is directed to the pressure booster along the at least one exhaust passage and, by controlling the opening/closing of the valve along the at least one exhaust passage, the exhaust from the engine can at least in part assist the reciprocating movement of the reciprocating member.

22. The system according to claim 1, wherein the engine serves as an internal combustion engine for a motor vehicle and provides fluid to at least in part operate the pressure booster.

23. The system according to claim 22, wherein the engine provides fluid to the pressure booster using exhaust gas from the engine.

24. A pressure booster system for use with an engine, comprising:
a pressure booster adapted for fluid communication with said engine, the pressure booster including a body and a reciprocating member disposed in the body; and
a compressed fluid storage tank in fluid communication with the pressure booster,
wherein the pressure booster is adapted to receive fluid from said engine and to use the fluid received from said engine to compress fluid within the pressure booster to supply compressed fluid to the storage tank.

25. The system according to claim 24, including a plurality of valves and the reciprocating movement of the reciprocating member is controlled or directed by the opening and/or closing of one or more valves.

26. The system according to claim 25, wherein the plurality of valves includes a first valve located along a fluid passage between said engine and a first pressure booster inlet, and a second valve located along a fluid passage between said engine and a second pressure booster inlet.

27. The system according to claim 26, wherein the first pressure booster inlet is in communication with a first chamber of the power booster, and the second pressure booster inlet is in communication with a second chamber of the power booster.

28. The system according to claim 27, wherein the plurality of valves further includes a third valve for exhausting fluid from the first chamber to atmosphere or an external environment; and a fourth valve located along a passage between the second chamber and the storage tank for supplying or charging the storage tank with compressed fluid.

29. A method for charging compressed fluid in a storage tank of a system, comprising:
providing fluid from an engine or air compressor;
operating a pressure booster with the fluid from the engine or air compressor; and
charging a compressed fluid storage tank with fluid from the pressure booster.

30. The method according to claim 29, wherein the operating step includes:
providing at least one valve in a passage that is in fluid communication with the engine or air compressor; and
opening/closing the at least one valve to at least assist with compression of fluid within the pressure booster.

31. The method according to claim 29, wherein the operating step includes:
closing a first valve associated with a first pressure booster inlet and opening a second valve associated with a second pressure booster inlet to assist with an upstroke of a reciprocating member within the pressure booster; and
opening the first valve and closing the second valve to assist with a down-stroke of the reciprocating member.

32. The method according to claim 29, wherein the operating step includes:
opening a valve associated with a pressure booster inlet to assist with an upstroke of a positive displacement pump of the pressure booster; and
closing the valve associated with the pressure booster inlet and proving a force to the positive displacement pump to cause a down-stroke of the positive displacement pump.
